(19) United States
(12) Patent Application Publication
(10) Pub. No.: US 2015/0179420 A1
(43) Pub. Date: Jun. 25, 2015

(54) Ionization System for Charged Particle Analyzers

(71) Applicant: Thermo Finnigan LLC, San Jose, CA (US)

(72) Inventor: Michael W. SENKO, Sunnyvale, CA (US)

(73) Assignee: Thermo Finnigan LLC, San Jose, CA (US)

(21) Appl. No.: 14/137,723

(22) Filed: Dec. 20, 2013

(51) Int. Cl. H01J 49/06; H01J 49/00

(52) U.S. Cl. CPC H01J 49/06; H01J 49/0031

(57) ABSTRACT

A sample ionization system includes at least an ionization source disposed at an ion source end of a charged particle analyzer, for selectably generating first ions in an analyzing mode of operation and second ions in a cleaning mode of operation. The first ions are one of positively and negatively charged and the second ions are the other one of positively and negatively charged. The second ions are directed through the charged particle analyzer toward a surface of an ion optic component, for at least partially neutralizing a buildup of charge caused by the first ions impinging on the surface of the at least one ion optic component.

### FIELD OF THE INVENTION

The invention relates generally to ionization systems for charged particle analyzers, and more particularly to ionization systems based on atmospheric pressure ionization (API) sources for use with mass spectrometers.

### BACKGROUND OF THE INVENTION

A charged particle analyzer, such as for instance a mass spectrometer, includes various ion optic components that are arranged to focus and/or guide ions between an ion source end and an analyzer end. Atmospheric pressure ionization (API) sources generate ions from a sample at atmospheric pressure for subsequent analysis using the charged particle analyzer. Typical examples of an API source include electrospray (ESI), atmospheric pressure chemical ionization (APCI) and atmospheric pressure photoionization (APPI), etc.

Unfortunately, in addition to producing the desired ions, an API source can also introduce neutral species that over time build up on surfaces of the charged particle analyzer. More particularly the neutral species tend to build up on surfaces of the various ion optic components that are adjacent to an ion flow path through the analyzer. Some of the ions travelling through the analyzer subsequently collide with such “dirty” surfaces (which tend to have a reduced electrical conductivity relative to a clean, uncontaminated surface) and impart a charge thereto. Under high throughput operating conditions, the build-up of neutral species and charge causes distortions in the electric fields that are produced by the application of predetermined voltages to the various ion optic components. These distortions reduce ion transmission efficiency through the instrument, resulting typically in lower instrument sensitivity. Further, in some instances a charge build-up can occur due to the ions striking the surfaces, even in the absence of a build-up of neutral species.

Typical mass spectrometer maintenance practice involves cleaning ion optic surfaces with the appropriate solvents to remove accumulated contaminants when a reduction in instrument sensitivity, indicative of charge build-up, is observed. Usually, such a cleaning process includes venting the vacuum system and removing covers to allow access to the contaminated surfaces. Although cleaning the ion optic surfaces will often restore the instrument sensitivity, it also results in excessive downtime for the instrument. This is a particular disadvantage in the case of instruments that requires ultrahigh vacuum conditions in the analyzer, such as an Orbitrap™ electrostatic ion trap mass analyzer or ion cyclotron resonance mass spectrometer, because a long bake out period is required after each vent to atmospheric pressure. Further, disassembling and reassembling the analyzer is both time consuming and tedious work.

It would be beneficial to provide a method and system that overcome at least some of the above-mentioned limitations and disadvantages of the prior art.

### SUMMARY OF THE INVENTION

In accordance with an aspect of at least one embodiment of the instant invention, there is provided a method for operating a charged particle analyzer, comprising: during a first period of time, generating one of positively charged ions and negatively charged ions at an ion source end of the charged particle analyzer; directing the ions that are generated during the first period of time along a first ion flow path defined between the ion source end and a mass analyzer end of the charged particle analyzer, the first ion flow path including at least one ion optic component disposed between the ion source end and the mass analyzer end, some of the ions that are generated during the first period of time impinging upon a surface of the at least one ion optic component and imparting a charge thereto; providing an electric field within the charged particle analyzer during the first period of time, the electric field supporting transmission of the ions that are generated during the first period of time along the first ion flow path; generating the other one of positively charged ions and negatively charged ions during a second period of time; directing the ions that are generated during the second period of time along a second ion flow path defined between the ion source end and the surface of the at least one ion optic component, such that at least some of the ions that are generated during the second period of time impinge upon the surface of the at least one ion optic component and at least partially neutralize the charge imparted by the ions that are generated during the first period of time; and modifying the electric field at least proximate the at least one ion optic component such that a greater fraction of the ions that are generated during the second period of time, relative to a fraction of the ions that are generated during the first period of time, impinges upon the surface of the at least one ion optic component.

In accordance with an aspect of at least one embodiment of the instant invention, there is provided a method for operating a charged particle analyzer, comprising: during a first period of time, generating one of positively charged ions and negatively charged ions at an ion source end of the charged particle analyzer; setting operating parameters of the charged particle analyzer to support transmission of the ions that are generated during the first period of time from the ion source end to a mass analyzer end of the charged particle analyzer, via at least one ion optic component; transmitting the ions that are generated during the first period of time along a direction toward the mass analyzer end, some of the ions that are generated during the first period of time impinging upon a surface of the at least one ion optic component and imparting a charge thereto; generating the other one of positively charged ions and negatively charged ions during a second period of time; adjusting at least one of the operating parameters of the charged particle analyzer to support transmission of the ions that are generated during the second period of time from the ion source end to the surface of the at least one ion optic component; and transmitting the ions that are generated during the second period of time along a direction toward the surface of the at least one ion optic component, such that at least some of the ions that are generated during the second period of time impinge upon the surface of the at least one ion optic component and at least partially neutralize the charge imparted by the ions that are generated during the first period of time.

In accordance with an aspect of at least one embodiment of the instant invention, there is provided a method for operating a charged particle analyzer, comprising: operating the charged particle analyzer in an analyzing mode of operation, comprising: using at least an ionization source, generating first ions having a first polarity; transmitting at least some of the first ions between the at least an ionization source and a mass analyzer of the charged particle analyzer, via at least one ion optic component; determining a measure of the operating performance of the charged particle analyzer; continuing to operate the charged particle analyzer in the analyzing mode of operation when the determined measure of the operating performance is greater than a predetermined threshold value; and switching the charged particle analyzer to a cleaning mode of operation when the determined measure of the operating performance is less than or equal to the predetermined threshold value, comprising: using the at least an ionization source, generating second ions having a second polarity that is opposite the first polarity; adjusting at least one operating parameters of the charged particle analyzer to support transmission of at least a portion of the second ions between the at least an ionization source and the surface of the at least one ion optic component; and transmitting the second ions such that the portion of the second ions impinges upon the surface of the at least one ion optic component and at least partially neutralizes the charge build-up thereon.

In accordance with an aspect of at least one embodiment of the instant invention, there is provided a sample ionization system for a charged particle analyzer having an ion source end, a mass analyzer end, and at least one ion optic component disposed between the ion source end and the mass analyzer end, the sample ionization system comprising: at least an ionization source for selectably generating positively charged ions and negatively charged ions at the ion source end of the charged particle analyzer; and, a controller for controlling the at least an ionization source to generate first ions when the charged particle analyzer is operating in an analyzing mode of operation and for controlling the ionization source to generate second ions when the charged particle analyzer is operating in a cleaning mode of operation, the first ions being one of positively charged and negatively charged and the second ions being the other one of positively charged and negatively charged, so as to at least partially neutralize a charge that builds-up on a surface of the at least one ion optic component during operation of the charged particle analyzer in the analyzing mode of operation.

### BRIEF DESCRIPTION OF THE DRAWINGS

The instant invention will now be described by way of example only, and with reference to the attached drawings, wherein similar reference numerals denote similar elements throughout the several views, and in which:

FIG. 1 is a simplified block diagram of a charged particle analyzer including an ionization system according to an embodiment of the invention.

FIG. 2 is a simplified block diagram of a charged particle analyzer including an ionization system according to another embodiment of the invention.

FIG. 3A is a simplified diagram showing an early stage of charge build-up, on a surface of an ion optic component, when the analyzer shown in FIG. 1 or FIG. 2 is operating in an analyzing mode.

FIG. 3B is a simplified diagram showing a later stage of charge build-up, on the surface of the ion optic component, when the analyzer shown in FIG. 1 or FIG. 2 is operating in the analyzing mode.

FIG. 3C is a simplified diagram showing negatively charged ions being directed toward the surface of the ion optic component, when the analyzer shown in FIG. 1 or FIG. 2 is operating in a cleaning mode.

FIG. 3D is a simplified diagram showing positively charged ions being transmitted via the ion optic component, when the analyzer shown in FIG. 1 or FIG. 2 is returned to operating in the analyzing mode after operating in the cleaning mode.

FIG. 4 is a Q0 flight time curve obtained for a charged particle analyzer with charge-build up.

FIG. 5 is a Q0 flight time curve obtained subsequent to the curve that is shown in FIG. 4, and after the charged particle analyzer has been operated in the cleaning mode.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

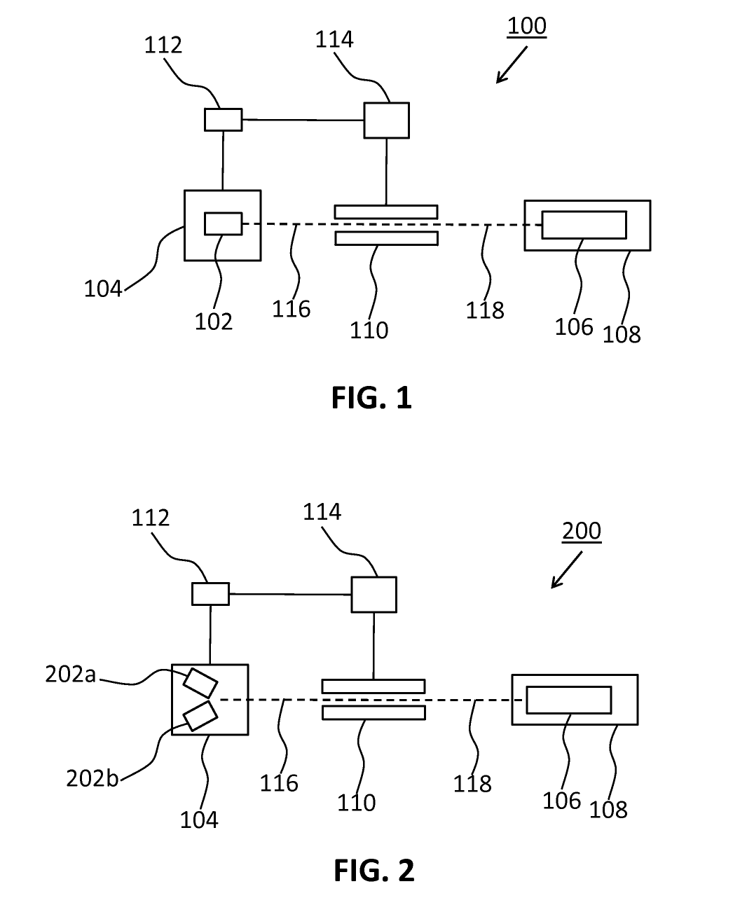

FIG. 1 is a simplified block diagram of a charged particle analyzer, which includes an ionization system according to an embodiment of the instant invention. The charged particle analyzer, shown generally at 100 in FIG. 1, includes an ionization source 102 disposed at an ion source end 104, an analyzer 106 disposed at an analyzer end 108, and at least one ion optic component 110 disposed between the ion source end 104 and the analyzer end 108. A controller 112 is in communication with the ionization source 102 and with a voltage generator 114. By way of a specific and non-limiting example, the charged particle analyzer 100 is a mass spectrometer, the ionization source 102 is an atmospheric pressure ionization (API) source, the analyzer 106 is a mass analyzer and the at least one ion optic component 110 is at least one of a multipole ion guide, an ion funnel, etc. The API source is optionally one of an electrospray (ESI) source, an atmospheric pressure chemical ionization (APCI) source, an atmospheric pressure photoionization (APPI) source, or another suitable API source. The mass analyzer is optionally one of a quadrupole mass filter, quadrupole ion trap, electrostatic ion trap (e.g., an Orbitrap analyzer), a time-of-flight mass analyzer, or another suitable mass analyzer.

During use, the charged particle analyzer 100 is selectably operable in an analyzing mode and in a cleaning mode. When operating in the analyzing mode the controller 112 controls the ionization source 102 to generate one of positively charged ions and negatively charged ions, which are transmitted via the at least one ion optic component 110 to the analyzer end 108 of the charged particle analyzer 100. For the purpose of this discussion, and by way of a specific and non-limiting example only, it is assumed that positively charged ions are generated during operation in the analyzing mode. Continuing with this discussion, the positively charged ions are separated by their mass-to-charge ratios (m/z's) and detected using the analyzer 106, such as for instance to generate a mass spectrum. To this end, the voltage generator 114 generates predetermined direct current (DC) and/or oscillatory voltage signals that are applied to the at least one ion optic component 110, resulting in the establishment of an electric field within the charged particle analyzer that supports transmission of the positively charged ions between the ion source end 104 and the analyzer end 108 with high transmission efficiency.

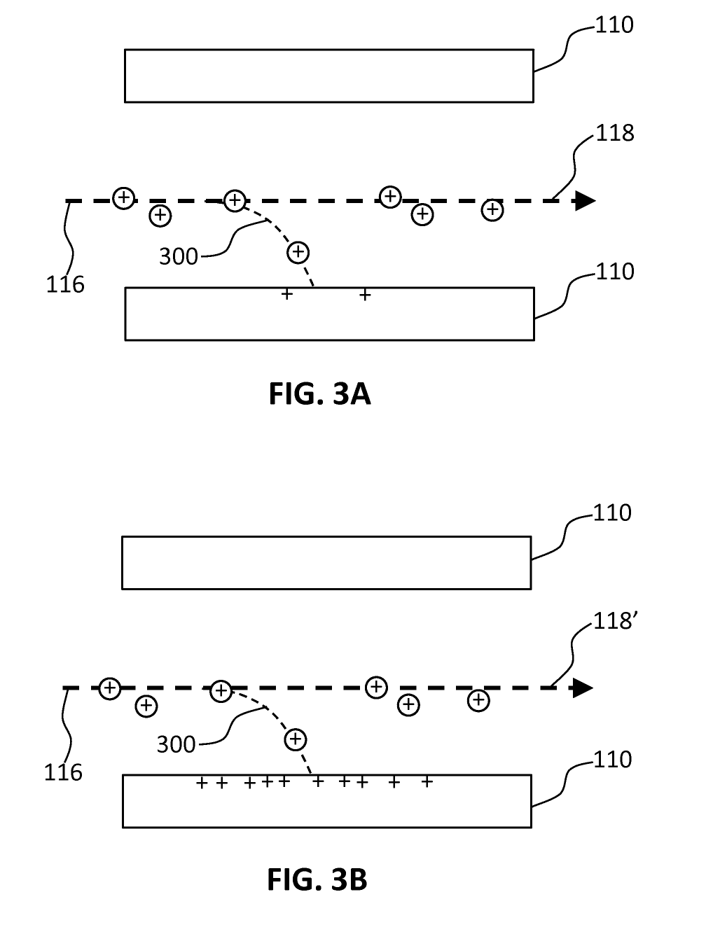

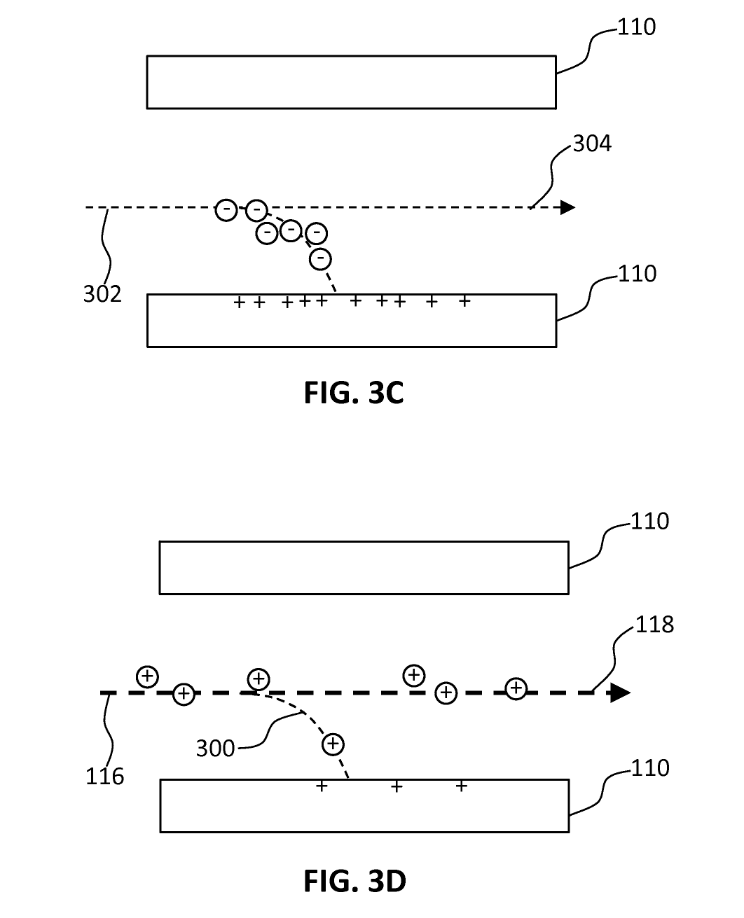

Nevertheless, as described in greater detail with reference to FIGS. 3A-D, some of the ions that are generated when operating in the analyzing mode are not transmitted successfully to the analyzer end 108 and are thus not separated and detected by the analyzer 106. More particularly, some of the positively charged ions that travel along a first portion 116 of an ion flow path between the ion source end 104 and the analyzer end 108 are moving along trajectories that become unstable (as used herein, the term “unstable” means that the trajectories developed by the ions depart significantly from the preferred ion path; it should not be construed as requiring the ions to have states that lie outside of the stability envelope defined by the Mathieu equation), and that result in said ions colliding with a surface of the charged particle analyzer 100, such as for instance a surface of the at least one ion optic component 110. As such, fewer ions travel along a second portion 118 of the ion flow path compared to the first portion 116 in FIG. 1. The ions that impinge upon the surface of the at least one ion optic component 110 impart thereto a positive charge (in this specific example). The build-up of charge on such surfaces causes aberrations in the electrical fields that are established within the charged particle analyzer 100, leading to reduced ion transmission efficiency and therefore lower instrument sensitivity.

When operating in the cleaning mode the controller 112 controls the ionization source 102 to generate the other one of positively charged ions and negatively charged ions, which in this example is negatively charged ions. For instance, the controller 112 reverses the polarity of the ionization source 102. As discussed in greater detail with reference to FIGS. 3A-D, the negatively charged ions are directed from the ion source end 104 toward the surface of the at least one ion optic component 110, such that at least some of the negatively charged ions undergo a collision with that surface. By way of a specific and non-limiting example, the controller 112 controls the voltage generator 114 to generate and apply a (DC and/or oscillatory) voltage signal to the at least one ion optic component 110 that results in an electrical field through which the negatively charged ions experience unstable trajectories. The negatively charged ions move along these unstable trajectories and at least a portion of these ions collide with the surface of the at least one ion optic component 110, causing them to neutralize a portion of the build-up of positive charge, thereby “cleaning” the surface.

More particularly, the controller 112 may control the voltage generator 114 to generate predetermined first voltages during operation in the analyzing mode and to generate predetermined second voltages during operation in the cleaning mode, at least one of the amplitude and polarity of the predetermined second voltages being different than that of the predetermined first voltages. The predetermined first and second voltages are applied to a component or components of the charged particle analyzer 100, such as for instance the at least one ion optic component 110, resulting in the establishment of the electrical fields that are used to control ion motion. As discussed supra the predetermined first voltages are selected such that positively charged ions (in the current example) are transmitted along an ion flow path, including the at least one ion optic component 110, to the analyzer 106 with high transmission efficiency. In an embodiment, the amplitudes of the predetermined second voltages are controlled to be lower than the amplitudes of the predetermined first voltages. Alternatively, switching between the analyzing mode and the cleaning mode involves using the controller 112 to control the voltage generator 114 to change at least one of an amplitude and a polarity of a voltage that is applied to a component that is disposed between the ion source end and the at least one ion optic component.

In a specific and non limiting example, the at least one ion optic component 110 is the Q0 quadrupole ion guide, which is operated in the analyzing mode normally with predetermined first oscillatory voltages having amplitudes of several hundred volts applied thereto, and which is operated in the cleaning mode with predetermined second oscillatory voltages having amplitudes of less than 100V applied thereto. Optimal values for the predetermined second voltages may be determined, for each component that is susceptible to acquiring a build-up of charge, by initially operating the charged particle analyzer 100 using an oscillatory voltage amplitude that results in high transmission efficiency of the negatively charged ions (in this example) by the component in question, and then reducing the oscillatory voltage amplitude that is applied to that component until 50% or more of the signal is lost. The observed signal reduction indicates that at least 50% of the normally transmitted ions are lost within the component in question, and are therefore available for neutralizing the charged surface thereof, although not all of the ions that are lost within the component necessarily strike the charged surface thereof.

As will be apparent, some ion optic components comprise an assembly of separate parts, such as for instance rods, and it is to be understood that the term “surface” as used herein is intended to include the aggregated surfaces of plural separate parts that are assembled together to form an ion optic component. As will be further apparent, the method that is described above may be repeated for each component that requires cleaning. The potential that is applied to each component is reduced or otherwise modified, one component at a time, while the potentials applied to all of the other components are maintained at values that support transmission of the ions with high transmission efficiency.

After a period of operation in the cleaning mode, the controller 112 returns the charged particle analyzer 100 to the analyzing mode of operation. In particular, the controller 112 returns the polarity of the ionization source 102 to the original polarity, and the ionization source 102 resumes generating positively charged ions. Optionally, a stabilizing period is provided after the ionization source 102 is returned to the original polarity.

Optionally, the analyzer 106 does not scan (i.e., separate and detect) the negatively charged ions that are generated when the charged particle analyzer 100 is operating in the cleaning mode of operation. Alternatively, the analyzer 106 does scan the negatively charged ions when the charged particle analyzer 100 is operating in the cleaning mode of operation. Further, when the negatively charged ions are scanned, then optionally the scan is not recorded to a data file.

Switching of the charged particle analyzer 100 between the analyzing mode and the cleaning mode optionally is a scheduled event, which occurs according to predetermined criteria. For instance, the charged particle analyzer 100 is operated in the analyzing mode during a complete first sample run, and then is switched to the cleaning mode during a period of time between the first sample run and a second immediately subsequent sample run. Alternatively, the charged particle analyzer 100 is switched between the analyzing mode and the cleaning mode at least one time during a sample run, and optionally a plurality of times during the sample run. For instance, the charged particle analyzer is switched between the analyzing mode and the cleaning mode during a period of time between two scans of the sample run. When switching to the cleaning mode occurs between two scans of the sample run, optionally the scan function is paused briefly. Of course, pausing the scan function lowers the overall scan rates. Further alternatively, the charged particle analyzer 100 is switched between the analyzing mode and the cleaning mode during a period of time in which the analyzer 106 is busy scanning, but does not require activity from the ionization source 102, in which case there is no impact on the overall scan rates.

In an alternative method for operating the charged particle analyzer 100, the step of switching from the analyzing mode of operation to the cleaning mode of operation is triggered in response to detecting an indication of charging of the surface of the at least one ion optic component 110. For instance, the indication of charging is inferred based on a comparison of the operation of the charged particle analyzer at two or more different times.

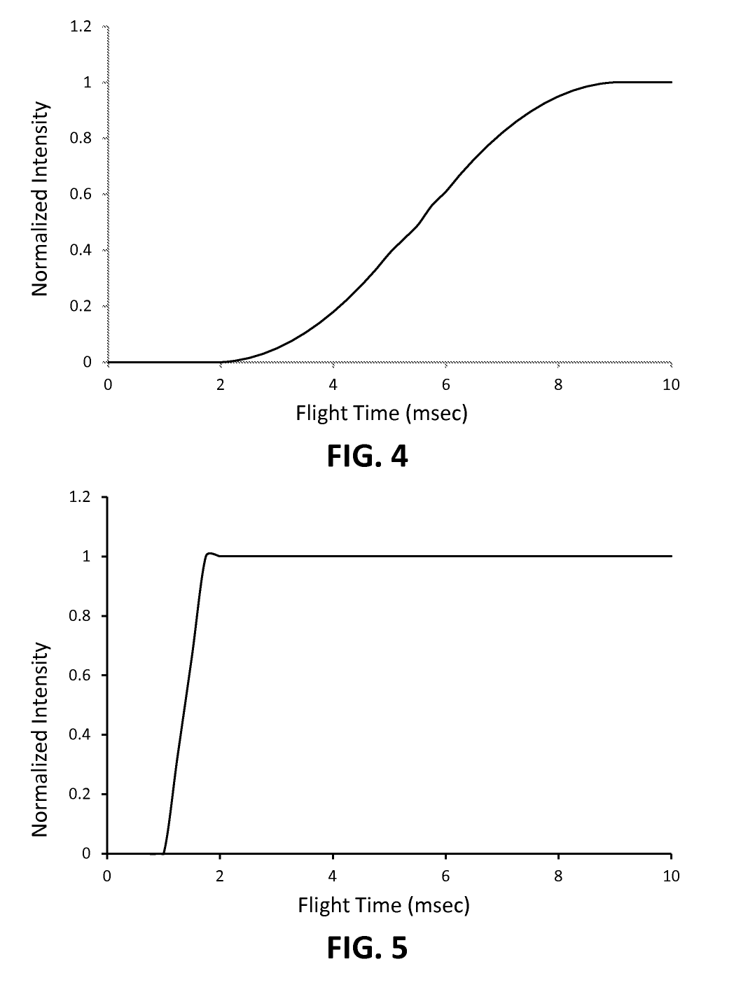

FIGS. 4 and 5 illustrate a mechanism that may be used for detecting the buildup of charge on component surfaces of the charged particle analyzer 100. In particular, FIGS. 4 and 5 show ion flight times in the front (e.g., Q0) of the charged particle analyzer 100. In both cases the ion beam is “turned off” and is then “turned back on,” and the time that it takes the ions to arrive at the analyzer 106 after the ion beam is turned back on is measured. In the case of some instruments this delayed arrival can be measured directly, using a not illustrated detector. For ion trap devices, however, it is necessary to collect a plurality of different scans, each scan being collected subsequent to a different period of time. If an ion optic component (e.g., Q0) has a charge buildup, then it takes longer for ions to fly across the device, as shown in FIG. 4. Without wishing to be held to any particular explanation of this effect, it is believed that the ions have fairly low energy in a device such as the charged particle analyzer 100 of FIG. 1, and as such the potential barrier that is created by the charge buildup on the ion optic component stops the ions temporarily. As a result, the ions may not be able to transit through the charged particle analyzer 100 until after a population of trapped ions has been accumulated that is sufficiently large to generate a potential that overwhelms the afore-mentioned potential barrier. The time (delay) that it takes to build up a large enough ion population is dependent on the flux coming from the source at any point in time, and is thus difficult to predict or control. In contrast FIG. 5 shows the behavior of the charged particle analyzer 100 when the ion optic component (e.g., Q0) does not have a substantial charge buildup. For instance, FIG. 5 shows the behavior of the charged particle analyzer 100 after discharging the previously charged ion optic component (e.g., Q0), which enables the ions to transit through the charged particle analyzer (i.e., Q0) without delay. As such, observing instrument behavior similar to the behavior that is depicted in FIG. 4 is an indication that the instrument requires cleaning.

According to one approach the charged particle analyzer 100 is operated in the analyzing mode, and determinations of a measure of the operating performance of the charged particle analyzer are made at periodic intervals. By way of an example, the measurement described with reference to FIGS. 4 and 5 is performed at periodic intervals. The charged particle analyzer 100 continues to operate in the analyzing mode as long as the determined measure of the operating performance is greater than a predetermined threshold value. For instance, operation in the analyzing mode continues as long as the intensity that is measured after a 2 msec delay time is at least 90% of the intensity that is measured after a 10 msec delay time, or some other suitable combination of delay times, as is illustrated in FIG. 5. When the determined measure of the operating performance falls below a predetermined threshold value, then the charged particle analyzer 100 is switched to the cleaning mode of operation. For instance, operation is switched to the cleaning mode when the intensity that is measured after a 2 msec delay time is less than 90% of the intensity that is measured after a 10 msec delay time, as is illustrated in FIG. 4. Optionally, a predetermined threshold value other than 90% is specified. Of course, other measures of the operating performance of the charged particle analyzer may be used for initiating operation in the cleaning mode.

According to another approach the measure of the operating performance of the charged particle analyzer 100 is determined immediately subsequent to operating the charged particle analyzer 100 in the cleaning mode. The determined measure is compared to a baseline range of values that is indicative of the absence of substantial charge-build up. When the determined measure is within the baseline range of values, then the charged particle analyzer 100 is switched from the cleaning mode to the analyzing mode. On the other hand, when the determined measure is outside of the baseline range of values, then operation continues in the cleaning mode. Referring again to FIGS. 4 and 5, one specific way of determining a measure of the operating performance includes measuring the signal intensity after delay times of 2 msec and 10 msec, or some other suitable combination of delay times. As is shown in FIG. 5, which corresponds to operation without substantial build-up of charge, the signal at 2 msec is approximately 100% of the intensity of the signal at 10 msec. As such, the baseline range may be selected to be, e.g., 90%-100%. If, subsequent to operating the charged particle analyzer 100 in the cleaning mode, the signal at 2 msec is less than 90% of the signal at 10 msec, as shown in e.g. FIG. 4, then operation in the cleaning mode continues since the determined measure of the operating performance of the charged particle analyzer 100 lies outside of the baseline range of 90%-100%. If on the other hand, subsequent to operating the charged particle analyzer 100 in the cleaning mode, the signal at 2 msec is less than 90% of the signal at 10 msec, as shown in FIG. 5, then operation is switched from the cleaning mode to the analyzing mode.

Optionally, when surfaces of plural components require cleaning, the controller 112 controls the voltage generator 114 to adjust the voltages that are applied to each of the plural components, one at a time, during a same period of operating in the cleaning mode. Alternatively, the controller controls the voltage generator 114 to adjust the voltage that is applied to a different one of the plural components during each of a plurality of different periods of operating in the cleaning mode. If the surfaces of some ion optic components build-up charge faster than the surfaces of other ion optic components, then optionally the ion optic components that build-up charge more quickly are subjected to more frequent and/or longer periods of operating in the cleaning mode of operation.

As will be apparent to a person having ordinary skill in the art, numerous components of the charged particle analyzer 100 have been omitted in FIG. 1, which has been done in the interest of providing improved clarity. In particular, the various vacuum stages, vacuum pumps, power supplies, atmosphere-to-vacuum ion transfer system, detector, electronic controllers and gas supplies, etc. are not shown or discussed.

FIG. 2 is a simplified block diagram of a charged particle analyzer, which includes an ionization system according to another embodiment of the instant invention. The charged particle analyzer, shown generally at 200 in FIG. 2, is similar to the charged particle analyzer 100, except separate ionization sources 202a and 202b are disposed at the ion source end 104. In particular, one of the ionization sources 202a is an API source that is used during operation of the charged particle analyzer in the analyzing mode. For instance, ionization source 202a is an ESI source that is used for generating positively charged ions, which are transmitted through the charged particle analyzer 200 and are scanned using the analyzer 106, in much the same way that has been described above with reference to FIG. 1 and the charged particle analyzer 100. The other one of the ionization sources 202b is, for instance, a front end electron transfer dissociation (ETD) source that is used for generating negatively charged ions, which are directed toward surface that are susceptible to acquiring a build-up of charge, also in much the same way that has also described above with reference to FIG. 1 and the charged particle analyzer 100.

Referring still to FIG. 2, the controller 112 selectably activates and deactivates respective ones of the ionization sources 202a and 202b for switching the charged particle analyzer 200 between the analyzing mode and the cleaning mode. Switching between two separate ionization sources 202a and 202b, instead of reversing the polarity of only one ionization source 102, eliminates the need to provide a stabilizing period between operating in the cleaning mode and operating in the analyzing mode. As discussed with reference to FIG. 1, optionally the analyzer 106 does not scan the negatively charged ions that are generated when the charged particle analyzer 200 is operating in the cleaning mode of operation. Alternatively, the analyzer 106 does scan the negatively charged ions when the charged particle analyzer 200 is operating in the cleaning mode of operation. Further, when the negatively charged ions are scanned, then optionally the scan is not recorded to a data file.

It will be apparent to a person having ordinary skill in the art that additional components, which are required to interface the two ionization sources 202a and 202b with the rest of the charged particle analyzer 200, have been omitted from FIG. 2. This has been done in the interest of providing improved clarity. Additionally, various other components of the charged particle analyzer 200 have been omitted from FIG. 2, including the various vacuum stages, vacuum pumps, power supplies, atmosphere-to-vacuum ion transfer system, detector, electronic controllers and gas supplies, etc., also in the interest of providing improved clarity.

The analyzing and cleaning modes of the charged particle analyzers 100 and 200 will now be discussed in greater detail, with reference to FIGS. 3A-3D. Shown in FIG. 3A are positively charged ions moving along the first portion 116 of the ion flow path, passing through the at least one ion optic component, and some of the ions continuing along the second portion 118 of the ion flow path. Some of the ions have an unstable trajectory 300 within the electric field proximate the at least one ion optic component 110, and ultimately collide with the surface of the at least one ion optic component 110, imparting a positive charge thereto. More particularly, FIG. 3A shows an early stage of charge build-up on the surface of the ion optic component 110, when the charged particle analyzer 100 or 200 is operating in the analyzing mode. FIG. 3B shows a later stage of charge build-up on the surface of the ion optic component 110, when the charged particle analyzer 100 or 200 is still operating in the analyzing mode. In the situation that is shown in FIG. 3B, the surface charge build-up is sufficient to cause aberrations in the electric field proximate the at least one ion optic component 110, such that the ions emerging therefrom continue along a portion of the ion flow path 118′ resulting in lower ion transmission efficiency and reduced instrument sensitivity relative to the situation in FIG. 3A. FIG. 3C shows the cleaning mode of operation, in which negatively charged ions are directed along an ion flow path 302 toward the surface of the ion optic component 110. Of course, some of the negatively charged ions do not collide with the surface of the ion optic component, and are represented as proceeding onward along trajectory 304. Finally, FIG. 3D shows the analyzing mode of operation subsequent to operating in the cleaning mode. In FIG. 3D the charged particle analyzer is restored to a condition similar to that shown in FIG. 3A.

While the above description constitutes a plurality of embodiments of the present invention, it will be appreciated that the present invention is susceptible to further modification and change without departing from the fair meaning of the accompanying claims.

What is claimed is:

1. A method for operating a charged particle analyzer, comprising:
during a first period of time, generating one of positively charged ions and negatively charged ions at an ion source end of the charged particle analyzer;
directing the ions that are generated during the first period of time along a first ion flow path defined between the ion source end and a mass analyzer end of the charged particle analyzer, the first ion flow path including at least one ion optic component disposed between the ion source end and the mass analyzer end, some of the ions that are generated during the first period of time impinging upon a surface of the at least one ion optic component and imparting a charge thereto;
providing an electric field within the charged particle analyzer during the first period of time, the electric field supporting transmission of the ions that are generated during the first period of time along the first ion flow path;
generating the other one of positively charged ions and negatively charged ions during a second period of time;
directing the ions that are generated during the second period of time along a second ion flow path defined between the ion source end and the surface of the at least one ion optic component, such that at least some of the ions that are generated during the second period of time impinge upon the surface of the at least one ion optic component and at least partially neutralize the charge imparted by the ions that are generated during the first period of time; and
modifying the electric field at least proximate the at least one ion optic component such that a greater fraction of the ions that are generated during the second period of time, relative to a fraction of the ions that are generated during the first period of time, impinges upon the surface of the at least one ion optic component.

2. A method according to claim 1, comprising applying a first predetermined voltage to the at least one ion optic component during transmitting of the ions that are generated during the first period of time, and wherein modifying the electric field at least proximate the at least one ion optic component comprises applying a second predetermined voltage to the at least one ion optic component during transmitting of the ions that are generated during the second period of time, the second predetermined voltage having at least one of an amplitude and a polarity different than that of the first predetermined voltage.

3. A method according to claim 1, wherein modifying the electric field at least proximate the at least one ion optic component comprises changing at least one of an amplitude and a polarity of a voltage that is applied to a component that is disposed between the ion source end and the at least one ion optic component.

4. A method according to claim 1, comprising switching an ionization source disposed at the ion source end from a first operating mode during the first period of time to a second operating mode during the second period of time.

5. A method according to claim 1, wherein the ions that are generated during the first period of time are generated using a first ionization source, and the ions that are generated during the second period of time are generated using a second ionization source.

6. A method according to claim 1, wherein the first period of time occurs during a first sample run and the second period of time occurs between the first sample run and a second immediately subsequent sample run.

7. A method according to claim 1, wherein the first period of time occurs during a sample run and the second period of time occurs between two successive scans of the sample run.

8. A method according to claim 1, wherein the first period of time and the second period of time occur during different portions of a single scan of a sample run.

9. A method according to claim 1, comprising:
determining a measure of the operating performance of the charged particle analyzer subsequent to the second period of time and comparing the determined measure to a baseline range of values that is indicative of the absence of substantial charge-build up on the at least one ion optic component; and
when the determined measure is outside of the baseline range of values, repeating the steps of generating the other one of positively charged ions and negatively charged ions and of directing the other one of positively charged ions and negatively charged ions along the second ion flow path.

10. A method for operating a charged particle analyzer, comprising:
during a first period of time, generating one of positively charged ions and negatively charged ions at an ion source end of the charged particle analyzer;
setting operating parameters of the charged particle analyzer to support transmission of the ions that are generated during the first period of time from the ion source end to a mass analyzer end of the charged particle analyzer, via at least one ion optic component;
transmitting the ions that are generated during the first period of time along a direction toward the mass analyzer end, some of the ions that are generated during the first period of time impinging upon a surface of the at least one ion optic component and imparting a charge thereto;
generating the other one of positively charged ions and negatively charged ions during a second period of time;
adjusting at least one of the operating parameters of the charged particle analyzer to support transmission of the ions that are generated during the second period of time from the ion source end to the surface of the at least one ion optic component; and
transmitting the ions that are generated during the second period of time along a direction toward the surface of the at least one ion optic component, such that at least some of the ions that are generated during the second period of time impinge upon the surface of the at least one ion optic component and at least partially neutralize the charge imparted by the ions that are generated during the first period of time.

11. A method according to claim 10, comprising:
determining a measure of the operating performance of the charged particle analyzer during transmission of the ions that are generated during the first period of time;
when the determined measure of the operating performance is greater than a predetermined threshold value, continuing to generate the one of positively charged ions and negatively charged ions at the ion source end; and
when the determined measure of the operating performance is less than or equal to the predetermined threshold value, controlling the at least one ion source to stop generating the one of positively charged ions and negatively charged ions and to begin generating the other one of positively charged ions and negatively charged ions.

12. A method according to claim 10, wherein the first period of time occurs during a first sample run and the second period of time occurs between the first sample run and a second immediately subsequent sample run.

13. A method according to claim 10, wherein the first period of time occurs during a sample run and the second period of time occurs between two successive scans of the sample run.

14. A method according to claim 10, wherein the first period of time and the second period of time occur during a single scan of a sample run.

15. A method according to claim 10, wherein:
setting the operating parameters of the charged particle analyzer comprises applying a first predetermined voltage to the at least one ion optic component; and
adjusting at least one of the operating parameters of the charged particle analyzer comprises applying a second predetermined voltage to the at least one ion optic component, the second predetermined voltage having at least one of an amplitude and a polarity different than that of the first predetermined voltage.

16. A method according to claim 10, wherein:
setting the operating parameters of the charged particle analyzer comprises applying a first predetermined voltage to a component that is disposed between the ion source end and the at least one ion optic component; and
adjusting at least one of the operating parameters of the charged particle analyzer comprises applying a second predetermined voltage to the component, the second predetermined voltage having at least one of an amplitude and a polarity different than that of the first predetermined voltage.

17. A method for operating a charged particle analyzer, comprising:
operating the charged particle analyzer in an analyzing mode of operation, comprising:
using at least an ionization source, generating first ions having a first polarity;
transmitting at least some of the first ions between the at least an ionization source and a mass analyzer of the charged particle analyzer, via at least one ion optic component;
determining a measure of the operating performance of the charged particle analyzer;
continuing to operate the charged particle analyzer in the analyzing mode of operation when the determined measure of the operating performance is greater than a predetermined threshold value; and
switching the charged particle analyzer to a cleaning mode of operation when the determined measure of the operating performance is less than or equal to the predetermined threshold value, comprising:
using the at least an ionization source, generating second ions having a second polarity that is opposite the first polarity;
adjusting at least one operating parameters of the charged particle analyzer to support transmission of at least a portion of the second ions between the at least an ionization source and the surface of the at least one ion optic component; and
transmitting the second ions such that the portion of the second ions impinges upon the surface of the at least one ion optic component and at least partially neutralizes the charge build-up thereon.

18. A method according to claim 17, comprising switching the at least an ionization source from a first operating mode when the charged particle analyzer is operating in the analyzing mode of operation to a second operating mode when the charged particle analyzer is operating in the cleaning mode of operation.

19. A method according to claim 17, wherein the at least an ionization source comprises a first ionization source and a second ionization source, the first ions being generated using the first ionization source and the second ions being generated using the second ionization source.

20. A method according to claim 17, wherein switching the charged particle analyzer to the cleaning mode comprises adjusting at least one of an amplitude and a polarity of a voltage that is applied to the at least one ion optic component relative to the at least one of the amplitude and the polarity that is applied when the charged particle analyzer is operated in the analyzer mode of operation.

21. A method according to claim 17, wherein switching the charged particle analyzer to the cleaning mode comprises adjusting at least one of an amplitude and a polarity of a voltage that is applied to a component that is disposed between the ionization source and the at least one ion optic component relative to the at least one of the amplitude and the polarity that is applied when the charged particle analyzer is operated in the analyzer mode of operation.

22. A method according to claim 17, wherein the charged particle analyzer is operated in the analyzer mode of operation during each of a plurality of sample runs, and wherein the charged particle analyzer is operated in the cleaning mode of operation between a first sample run and a second immediately subsequent sample run of the plurality of sample runs.

23. A method according to claim 17, wherein the charged particle analyzer is operated in the analyzer mode of operation during each of a plurality of scans of a sample run, and wherein the charged particle analyzer is operated in the cleaning mode of operation between two successive scans of the sample run.

24. A method according to claim 17, wherein the charged particle analyzer is operated in the analyzer mode of operation during a first portion of a scan, and wherein the charged particle analyzer is operated in the cleaning mode of operation during a second portion of the same scan.

25. A sample ionization system for a charged particle analyzer having an ion source end, a mass analyzer end, and at least one ion optic component disposed between the ion source end and the mass analyzer end, the sample ionization system comprising:
at least an ionization source for selectably generating positively charged ions and negatively charged ions at the ion source end of the charged particle analyzer; and,
a controller for controlling the at least an ionization source to generate first ions when the charged particle analyzer is operating in an analyzing mode of operation and for controlling the ionization source to generate second ions when the charged particle analyzer is operating in a cleaning mode of operation, the first ions being one of positively charged and negatively charged and the second ions being the other one of positively charged and negatively charged, so as to at least partially neutralize a charge that builds-up on a surface of the at least one ion optic component during operation of the charged particle analyzer in the analyzing mode of operation.

26. A sample ionization system according to claim 25, wherein the controller comprises an output port for providing a control signal to a voltage generator for controlling at least one of an amplitude and a polarity of a voltage that is applied to the at least one ion optic component, the voltage generator for adjusting the at least one of the amplitude and the polarity of the voltage in response to the control signal for switching the charged particle analyzer between the analyzing mode of operation and the cleaning mode of operation.

27. A sample ionization system according to claim 25, wherein the at least an ionization source comprises one ionization source, and wherein the one ionization source is selectably operable in a first mode for generating the first ions and in a second mode for generating the second ions.

28. A sample ionization system according to claim 25, wherein the at least an ionization source comprises a first ionization source and a second ionization source, and wherein in response to control signals from the controller the first ions are generated using the first ionization source and the second ions are generated using the second ionization source.
